(19) United States
(12) Patent Application Publication
(10) Pub. No.: US 2014/0015929 A1
(43) Pub. Date: Jan. 16, 2014

(54) THREE DIMENSIONAL SCANNING WITH PATTERNED COVERING

(71) Applicants: Seungwook HONG, San Diego, CA (US); Djung NGUYEN, San Diego, CA (US); Megan Marie FARRELL, San Diego, CA (US)

(72) Inventors: Seungwook HONG, San Diego, CA (US); Djung NGUYEN, San Diego, CA (US); Megan Marie FARRELL, San Diego, CA (US)

(73) Assignee: SONY CORPORATION, Tokyo (JP)

(21) Appl. No.: 13/547,999

(22) Filed: Jul. 12, 2012

(51) Int. Cl. G06K 9/62; H04N 13/02

(52) U.S. Cl. 348/46; 382/154; 348/E13.074

(57) ABSTRACT

A method for obtaining 3D information of an object including the steps of retrieving two or more images of the object, the object being covered in an elastic covering comprising a uniform, matching a plurality of corresponding points in the two or more images based on the pattern, and generating a point cloud representing an object based the plurality of corresponding points.

### BACKGROUND OF THE INVENTION

1. Field of the Invention

The present invention relates generally to three-dimensional (3D) scanning, and more specifically to 3D information acquisition. Even more specifically, the present invention relates to using a patterned covering to enhance 3D data acquisition.

2. Discussion of the Related Art

Three-dimensional scanning involves the analysis of real-world objects to collect data in order to construct a digital model of the object. Reconstructed digital models of real-world objects are increasing being used in various fields such as in engineering, manufacturing, military, medical, and entertainment industries, as well as in historic and scientific researches.

### SUMMARY OF THE INVENTION

Several embodiments of the invention provide a system and method for scanning an object to construct a 3D model.

In one embodiment, the invention can be characterized as a method for obtaining 3D information of an object that includes the steps of retrieving two or more images of an object being covered in an elastic covering comprising a uniform pattern, matching a plurality of corresponding points in the two or more images based on the uniform pattern, and generating a point cloud representing an object based the plurality of corresponding points.

In another embodiment, the invention can be characterized as a system for obtaining 3D information of an object that includes a storage device for storing a two or more images of an object that is covered in an elastic covering comprising a uniform pattern, and a processor for generating a digital model of the object matching a plurality of corresponding points in the two or more images based on the uniform pattern to generate a point cloud representing an object.

In a further embodiment, the invention may be characterized as a system for obtaining 3D information of an object that includes a camera system for capturing a object from a plurality of view points to output two or more images, an elastic covering adapted to substantially follow the contour of the object, the covering having a uniform pattern, and a processor-based system for matching a plurality of corresponding points in the two or more images based on the uniform pattern of the elastic covering and generating a point cloud based on the corresponding points.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a block diagram of a system for performing a 3D scan according to one or more embodiments.

FIG. 2 is a flow diagram of a process for performing a 3D scan according to one or more embodiments.

FIGS. 3 A-F are illustrations of patterns that can be used in a 3D scanning process according to one or more embodiments.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

One method of obtaining 3D information of an object is through stereophotogrammetry, in which one or more 2D images are analyzed to derive 3D information of the object captured in the images. Particularly, 3D information may be obtained by comparing images taken of a surface of an object from two or more viewpoints based on the principle of stereoscopy. Passive stereophotogrammetry method typically does not require specialize instruments, and can be performed with commercial cameras.

One difficulty associated with the stereophotogrammetry, however, is that corresponding points in images taken from different viewpoints are not always easily matched. Corresponding points are the points in two images that represent the same point on an object. In conventional passive stereoscopic scanning, identifiable shapes and features on the object are often relied on to provide references points for performing corresponding points matching. For example, the outline of the object can be used to align the images to match corresponding points. In some instances, identifiable features on an object can be aligned to match corresponding points. However, it is often difficult to obtain sufficient density of identifier to accurately match corresponding points. Corresponding points matching problem is especially pronounced when the object has flat surfaces or periodic textures, resulting in poor accuracy in the reconstructed 3D model.

Structured-light 3D scanners have been proposed as one way of improving 3D scanning. In a structured-light 3D scanner, a light pattern is projected onto a three-dimensionally shaped surface to produce lines of illuminations that appears distorted from other perspectives than that of the projector. The line distortions provide information in understanding the 3D surface. However, the structured-light scanning method suffers from several limitations. First, because a light pattern is projected and reflected on the surface of the object, such scanner typically perform poorly with reflective or transparent surface. It is also hard for structured-light scanners to handle translucent materials, such as skin, marble, wax, plants and human tissue because of the phenomenon of sub-surface scattering. Additionally, a structured light scanner assembly typically requires a separate projector in additional to the cameras. If the scanning of a large object is desired, the projector and the object have to be substantially spaced apart, thus requiring a large space to perform the scan. Therefore, a structured-light scanner assembly capable of scanning a large object can be costly, lack mobility, and space consuming. Due to these limitations, structured-light light scanner is not an ideal scanner in many situations.

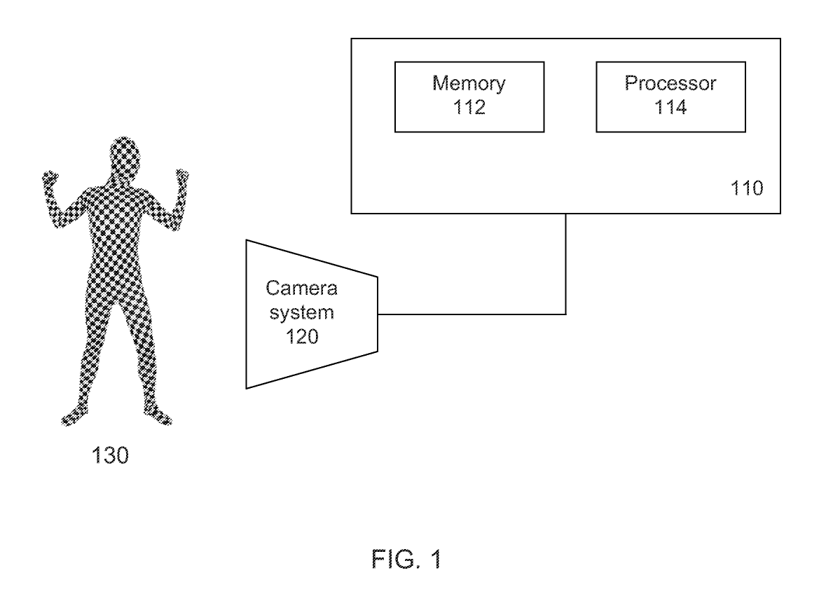

Referring first to FIG. 1, a block diagram of a system for performing a 3D scan according to one or more embodiment of the present invention is shown. The system shown in FIG. 1 generates a 3D model of an object covered in a patterned covering. The system includes a processor based device 110 having a memory 112 and a processor 114, and a camera 120 for capturing images from a real-world object 130.

The processor based device 110 may be a computer or any device capable of processing data. The memory 112 may be a RAM or ROM memory device or any non-transitory computer readable storage medium. The processor 114 may be a central processing unit (CPU), a dedicated a graphic processor (GPU), or a combination of a CPU and GPU in the processor based device 110. In some embodiments, the processor based device 110 may include two or more networked devices.

The camera system 120 may include one or more cameras for capturing images of the object 130, including the pattern of the covering on the object 130. In some embodiments, the camera system 120 is a stereoscopic camera for performing passive 3D scanning. Images captured by a stereoscopic camera can be processed to obtain a depth map of the object. In some embodiments, the camera system 120 includes multiple cameras surrounding the object 130 to capture images of the object from multiple angles. In some embodiments, the camera system 120 includes one or more cameras that are rotated around the object 130 to capture the object 130 from multiple angles. In some embodiments, the object 130 is placed on a turntable or other apparatus for rotating the object 130, and the camera system 120 is stationary. In some embodiments, mirrors are used to enable the camera system 120 to capture different angle and surface of the object 130. In some embodiments, the camera system 120 includes cameras for capturing radiation not visible to naked human eyes, such as radiations in ultraviolet or infrared ranges.

While the camera system 120 is shown to be connected to the processor based device 110 through a solid line in FIG. 1, the camera system 120 is not necessarily connected to the processor based device 110 during a scanning process. The data recorded by the camera system 120 can be transmitted to the processor based system 110 through wired (e.g. cable, USB cable, wired network cable etc,) or wireless (e.g. Wi-Fi, blue-tooth, wireless HDMI etc.) connections during or after the scanning process, or transferred through a portable storage medium (e.g. hard drive, thumb drive, memory card, etc.) after the scanning process.

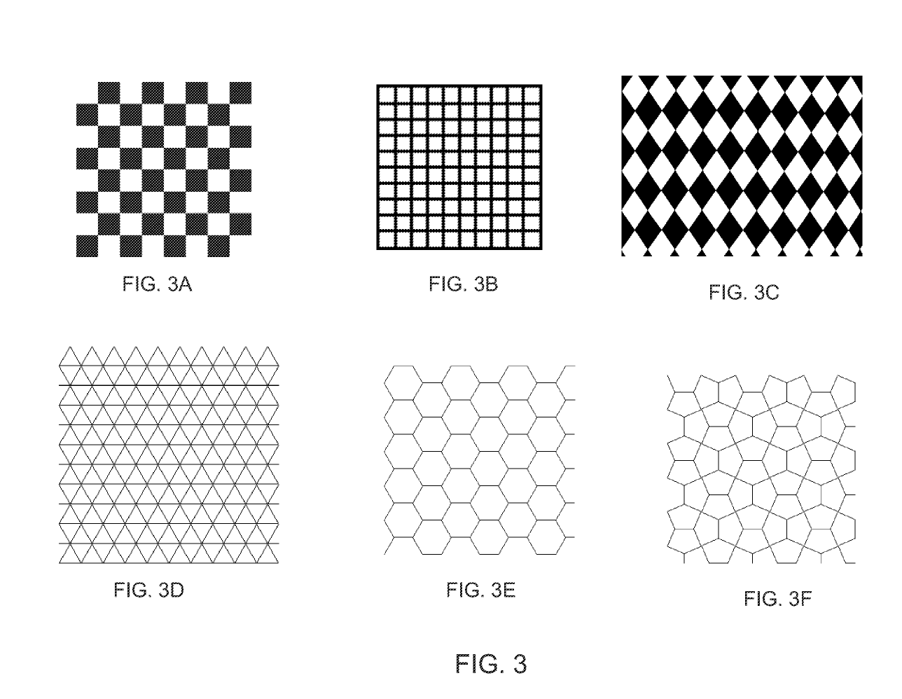

The object 130 may be any real-world object. In FIG. 1, a human being is illustrated as the object 130 being scanned. In some embodiments, the object 130 may be an animal, an artifact, a sculpture, a prop, a structure, etc. In some embodiments, the object 130 is covered in a patterned covering. The covering may be made of an elastic fabric such as leggings, stockings, hosiery, spandex, and fishnet stockings, which is adapted to conform to the contour of the object 130. The object 130 may be partially or entirely covered in the covering. In some embodiments the covering may be specifically tailored to fit the object or object type. For example, the covering may be a body stocking made to generally conform to the contour of an average human body. In some embodiments, the covering may be custom-made stocking tailored for a specific person. In some embodiment, the covering may be opaque, transparent, translucent, or made of a net-like material with perforations forming patterns. In some embodiments, the covering has multiple sections having patterns in different densities. For example, on a full body stocking, the pattern on portions of the stocking for covering a human calf may be less dense than the portions for covering a human thigh, to accommodate the stretching that occurs when the stocking is worn. The covering may have a pattern in black and white, or include two or more colors. The pattern may be printed on transparent, translucent, or opaque material. A detailed description of the pattern of the covering is provided with reference to FIG. 3 hereinafter.

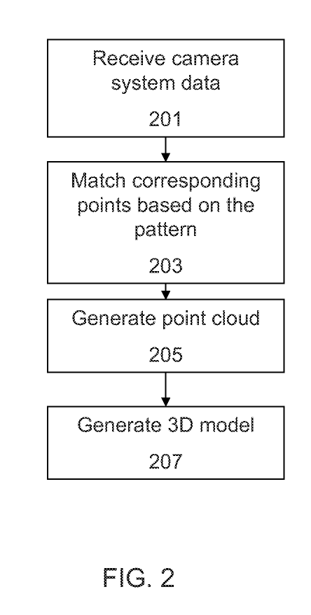

When an object 130 is scanned by the camera 120, the captured data is provided to the processor based system 110 and stored in the memory 112. The processor 114 then processes the captured data to generate a point cloud. The point cloud can be generated by matching corresponding points using the pattern on the covering as guide. In some embodiments, the system also generates a reconstructed 3D model representing the object based on the point cloud by referencing the pattern. The process of generating the 3D model is described in further detail with reference to FIG. 2 hereinafter. In some embodiments, the reconstructed 3D model represents a surface or a portion of the object 130. In some embodiments, the reconstructed 3D model may be a wire-frame model such as a polygonal mesh, a curve model, or other digital representation of a 3D object.

Referring next to FIG. 2, a flow diagram of a process for generating a 3D model is shown. In step 201, data is received from a camera system capturing images of an object. The data provided by the camera system may include two or more 2D images of the object taken from different viewpoints. The data may be transferred from a camera to a processor based system during the image capture or after the image capture is completed. The data may be transferred through wired or wireless connection, or through a portable storage medium.

In step 203, corresponding points on images received form the camera is matched based on a pattern of the covering on the scanned object. As mentioned previously, structured-light method suffers from various limitations due to the use of projected light pattern on the surface of the object. By covering the object with a patterned covering, the scanner assembly does not need to include a projector, and the space require to scan a large object is also significantly reduce. The covering also eliminates the issues structured-light scanners have with reflective, transparent, and translucent surfaces. The use of the covering provides a passive scanning method, in which no radiation is shined on the object, while providing many advantages of an active scanner.

In some embodiments, the covering is made of an elastic material which allows the covering to stretch and contour according to the shape and contour of the object. The pattern may be a uniform pattern consisting repetitive elements, or cells, such as a checkerboard pattern. In some embodiments, a computer analyzing the images can match corresponding points on the object based on the information provided by the pattern on the covering. In some embodiments, the pattern functions as a grid on the surface of the object on which corresponding points can be mapped. In some embodiments, features, such as line intersections on the pattern, can be directly used as corresponding points. In some embodiments, the pattern can enhance the accuracy and/or efficiency of corresponding points matching by providing identifiable features on the surface of the object as reference points. In some embodiments, the intersections of a grid pattern can be used as reference points. In some embodiments, corners of cells in a pattern can be used as reference points. In one embodiment, the change in size of cells of the pattern caused by the stretching of the covering can used to align two or more images of the object taken from different points of view. That is, while the pattern may be a substantially uniform pattern having repetitive elements, the contouring and stretching of the covering cause by the contours of the object can create uniquely identifiable features that a computer can use to align two or more images to match corresponding points. The contouring of lines of the pattern can also provide similar information regarding contours of a surface as the distortion of light bean projected on a surface in the structured-lighting method. For example, the contouring of the lines on the pattern can provide information regarding the curvature of the surface. In some embodiments, the pattern enhances the perceptibility of the contours on a monochromic object in an image. In some embodiments, the pattern provides information for measuring the size of the object. For example, by knowing the size of a cell on the pattern, the size of the object can be determined by the relative size of the object as compared to the cell.

In step 205 a point cloud representing the object is generated. A point cloud is a set of vertices on a three-dimensional coordinate system. A point cloud representing an object is generated based on the data received in step 201 and the matching of corresponding points in step 203. Once corresponding points from multiple images are matched, the point cloud can be generated based on two or more images of the object. Stereophotogrammetry operates on the principle that distances between a camera and a point on the object can be determined by the slight difference between images of the object taken from different points of view. For example, a distance (R) between a point on the object and the first camera can be determined using the following equation:

$$R = \frac{tan ( \frac{π }{2} - {α}_{1} ) \times tan ( \frac{π}{2} - {α}_{2} ) \times Δ X}{tan ( \frac{π}{2} - {α}_{1} ) + tan ( \frac{π}{2} - {α}_{2} )}$$

In the above equation, α₁ is the angle between a first camera and the point, α₂ is the angle between a second camera and the point, and ΔX is the distance between the two cameras. In some embodiments, angles α₁ and α₂ can be determined from images taken by the first and second cameras, respectively. In some embodiments, at least some of the images used to generate the point cloud are taken by the same camera that is moved relative to the object between image captures. In such a case, ΔX is the distance between locations of the camera when each image is captures.

The above equation is provided only as an example; other methods associates with stereophotogrammetry can also be used in accordance with some embodiments. Distance R can also be calculated based on three or more images using similar methods.

In step 207, a digital model of the object is generated. In some embodiments, the digital model is a polygonal model, a mesh model, and/or a wire-frame model representing the object. There are many techniques for converting a point cloud to a 3D surface. Some approaches, like Delaunay triangulation, alpha shapes, and ball pivoting, build a network of triangles over the existing vertices of the point cloud, while other approaches convert the point cloud into a volumetric distance field and reconstruct the implicit surface so defined through a marching cubes algorithm.

In some embodiments, the pattern of the covering of the object enhances the surface reconstruction of the 3D model by providing information regarding which points in the point cloud should be grouped together to form a surface. In some embodiments, the boundaries of the elements of the pattern forms boundaries of a cell into which points may be grouped. In some embodiments, the grouping of points may be stored when the point cloud is generated. The grouping information is then used to reconstruct the surfaces of the 3D model. The grouping information may reduce the error in 3D surface reconstruction and increase the accuracy of the generated 3D model. Without the grouping information, points from different surfaces of the object could be erroneously reconstructed onto a single surface, causing inaccuracies and distortion in the 3D model. The grouping may also reduce the computing time required to determine the surface structure of the 3D model.

The method described with references to FIG. 2 may be performed by a computer or any device capable of processing data. In some embodiments, the pattern information is used to match corresponding points in step 203 but not used to generate the 3D model in step 207. In some embodiments, the pattern information used in both step 203 and 207. In some embodiments, steps 203, 205, and 207 are performed on different devices. For example, one system may generate the point cloud and pass the point cloud data to another device to generate a 3D model. In some embodiments, the point cloud data is generated and stored without further processing.

Referring next to FIG. 3, examples of patterns that may be used in one or more embodiments of the present invention is shown. A covering having patterns may be used to cover an object in the method and system described with reference to FIGS. 1 and 2 above to enhance definition and accuracy of the 3D scanning process. In some embodiments, the pattern may be used to enhance the efficiency and accuracy of the reconstruction of 3D surface from a point cloud. In some embodiments, the pattern allows the cameras to perform measurement of the object.

In some embodiments, the pattern is a grid-like uniform pattern. In some embodiments, the pattern includes repetitive tiled elements or cells. The cells can be a number of geometric shapes, and the intersections of lines or corners of cells can be used as reference points to match corresponding points between images of an object taken from different viewpoints. The boundaries of the cell can serve to group neighboring points on a surface together to increase the accuracy of the reconstruction of the 3D model. In some embodiments, each cell of the pattern has the same size. In some embodiments, each cell is identical or nearly identical to each other in appearance before it is fitted on the object.

FIGS. 3A-F are examples of patterns that can be used with the system and method described with reference to FIGS. 1 and 2 above. FIG. 3A shows a checkerboard pattern. The use of alternating black and white cells has the advantage of having zero boundary line thickness. That is, the transition between black and white defines the boundary of each cell. Each point at which two white cells and two black cells meet can be used as a references point for determining corresponding points. FIG. 3B shows a square grid pattern. Grids with different cell sizes and shapes may be used. The intersections of grid lines provide reference points for corresponding point matching. Each cell defines a surface area for grouping point cloud points. FIG. 3C is a diamond pattern having alternating black and white cells similar to the pattern shown in FIG. 3A. Shapes other than squares can also be used to form grids in which each cell is substantially equal in size. FIG. 3D is a pattern including a tessellation of triangular cells. Triangular cells also provide intersections and cell boundaries that provide information for the reconstruction of the 3D model. FIGS. 3E and 3F are patterns including a tessellation of hexagons and pentagons respectively. Both patterns also provide cell corners and boundaries easily identifiable by a computer program to provide information in the reconstruction of a 3D model.

FIGS. 3A-F are provided as example patterns only. A number of possible patterns can be used in the system and method described with reference to FIGS. 1 and 2. In some embodiments, the pattern may include cells of alternating two or more colors. In some embodiments, the pattern may be printed on or woven into the fabric of the covering. In some embodiments, the covering is a net like material in which perforations are the cells of the pattern. For example, the covering may be a fishnet stocking. The covering and/or the pattern may be opaque, transparent, or translucent. In some embodiments, the pattern may be printed in ink only visible under certain light (e.g. ultraviolet) or only visible to specific types of camera (e.g. infrared camera). The covering may be made of any elastic or stretchable material, such as spandex, eslastane, stockings, hosiery etc.

In some embodiments, the cells of the pattern has one density in one area and a higher density in a second area to provide better resolution to accommodate different contours. For example, on a full body stocking warn by a person, the pattern to be worn around the thigh area may be denser (i.e. cells are smaller) than the pattern to be worn around the calf area. Since fabric is likely to be stretched out more around the thigh area, the denser pattern can ensure that images of the thigh area have sufficient density of reference points and small enough cell areas to provide effective information for matching corresponding points, and in the reconstruction of 3D model.

In some of the embodiments described above, a 3D scanning can be performed with one or more commercial cameras without the need of extra equipments such as a light pattern projector. The method also does not require a large space to perform the scan, since the projection of light beams is not required. By using fabric coverings to provide a grid-like pattern on the object being scanned, the scanning process can be made more cost effective, efficient, accurate, and space saving.

While the invention herein disclosed has been described by means of specific embodiments, examples and applications thereof, numerous modifications and variations could be made thereto by those skilled in the art without departing from the scope of the invention set forth in the claims.

What is claimed is:

1. A method for obtaining 3D information from an object comprising:
retrieving two or more images of the object, the object being covered in an elastic covering comprising a uniform pattern;
matching a plurality of corresponding points in the two or more images based on the uniform pattern; and
generating a point cloud representing an object based the plurality of corresponding points.

2. The method of claim 1 wherein the pattern comprises a plurality of substantially identical cells.

3. The method of claim 1 wherein the pattern comprises a tessellation of a repeated geometric shape.

4. The method of claim 1 wherein the pattern comprises a checkerboard pattern or a grid pattern.

5. The method of claim 1 wherein the matching of the plurality of corresponding points uses features the uniform pattern as reference points.

6. The method of claim 1 further comprising:
generating a 3D model of the object based on the point cloud and the uniform pattern.

7. The method of claim 6 wherein the generating of digital model step comprises:
grouping points of the point cloud that falls within each cells of the pattern; and
generating the 3D model based on the grouping of the points.

8. The method of claim 1 wherein the elastic covering comprises at least one of spandex, stockings, fishnet stockings, hosiery, or tights.

9. The method of claim 1 wherein the elastic covering comprises a plurality of sections and the pattern in a first section has a higher density than the pattern in a second section.

10. The method of claim 1 wherein the two or more images are captured from different points of view by a stereoscopic camera system.

11. A system for obtaining 3D information of an object comprising:
a storage device for storing a two or more images of the object, the object being covered in an elastic covering comprising a uniform pattern; and
a processor for generating a digital model of the object matching a plurality of corresponding points in the two or more images based on the uniform pattern to generate a point cloud representing the object.

12. The system of claim 11 wherein the uniform pattern comprise a plurality of identical cells.

13. The system of claim 11 wherein the pattern comprises a tessellation of a repeated geometric shape.

14. The system of claim 11 wherein the pattern comprises a checkerboard pattern or a grid pattern.

15. The system of claim 11 wherein the matching of the plurality of corresponding points uses features the pattern as reference points.

16. The system of claim 11 wherein the processor is further adapted to generate a 3D model of the object based on the point cloud.

17. The system of claim 16 wherein the processor generates the 3D model by grouping points of the point cloud that falls within each of the cells of the pattern, and generates the 3D model based on the grouping of the points.

18. The system of claim 11 wherein the elastic covering comprises at least one of spandex, stockings, fishnet stockings, hosiery, or tights.

19. The system of claim 11 wherein the elastic covering comprises a plurality of sections and the pattern in a first section has a higher density than the pattern in a second section.

20. A system for obtaining 3D information of an object comprising:
a camera system for capturing an object from a plurality of viewpoints to output two or more images;
an elastic covering adapted to substantially follow the contour of the object, the covering having a uniform pattern; and
a processor-based system for matching a plurality of corresponding points in the two or more images based on the pattern of the elastic covering and generating a point cloud based on the matched corresponding points.
